(19) United States
(12) Patent Application Publication
(10) Pub. No.: US 2023/0118145 A1
(43) Pub. Date: Apr. 20, 2023

(54) INFORMATION PROCESSING DEVICE, CONTROL METHOD AND STORAGE MEDIUM

(71) Applicant: NEC Corporation, Minato-ku, Tokyo (JP)

(72) Inventors: Tatsuya MATSUOKA, Tokyo (JP); Naoto OHSAKA, Tokyo (JP); Akihiro YABE, Tokyo (JP)

(73) Assignee: NEC Corporation, Minato-ku, Tokyo (JP)

(21) Appl. No.: 17/911,777

(22) PCT Filed: Mar. 31, 2020
(86) PCT No.: PCT/JP2020/014899

§ 371 Date: Sep. 15, 2022

(51) Int. Cl. G06Q 30/0601

(52) U.S. Cl. CPC G06Q 30/0609

(57) ABSTRACT

The first candidate determination means 15B is configured to determine, based on seller information 41B indicating a sale condition of a transaction target presented by each of sellers and buyer information 42B indicating a buy condition of the transaction target presented by each of buyers, first candidates C1x to be plural candidates for combinations of the sellers and the buyers establishing valid transactions of the transaction target. The second candidate selection means 16B is configured to select plural second candidates C2x to be displayed from the first candidates C1x based on similarity among the first candidates C1x.

### TECHNICAL FIELD

The present invention relates to a technical field of an information processing device, a control method, and a storage medium for performing processing related to transactions.

### BACKGROUND ART

There are known systems to support matching of sellers and buyer of goods. For example, Patent Literature 1 discloses an electronic transaction mediation system configured to generate a plurality of candidates of combinations of traders and customers to meet desired trading conditions of both the traders and the customers at the same time. Further, Non-Patent Literature 1 discloses a technique relating to sampling using determinantal point processes.

### CITATION LIST

### Patent Literature

Patent Literature 1: WO2002/027575

### Non-Patent Literature

Non-Patent Literature 1: A. Kulesza and B. Taskar. k-DPPs: Fixed-size determinantal point processes. In Proceedings of the 28th International Conference on Machine Learning, pp. 1193-1200, 2011.

### SUMMARY

### Problem to be Solved

Mediators (dealers) such as commercial companies that mediate transactions must combine (match) sellers of target goods of the transactions with buyers to meet the transaction conditions, such as the trading volume and the price, desired by the sellers and the buyers. In general, it is also necessary for the mediator to determine the optimal matching by negotiating with trading partners as appropriate. Therefore, even when presenting a plurality of candidates of the combinations which satisfy the desired trading conditions as in Patent Literature 1, it may not be sufficient information for the mediator when similar matching candidates are presented.

In view of the issues described above, one object of the present invention is to provide an information processing device, a control method, and a storage medium capable of suitably determining candidates for combinations of sellers and buyers of a transaction target.

### Means for Solving the Problem

In one mode of the control device, there is provided a control device including: a first candidate determination means configured to determine, based on seller information indicating a sale condition of a transaction target presented by each of sellers and buyer information indicating a buy condition of the transaction target presented by each of buyers, first candidates to be plural candidates for combinations of the sellers and the buyers establishing valid transactions of the transaction target; and a second candidate selection means configured to select plural second candidates to be displayed from the first candidates based on similarity among the first candidates.

In one mode of the control method, there is provided a control method executed by a computer, the control method including: determining, based on seller information indicating a sale condition of a transaction target presented by each of sellers and buyer information indicating a buy condition of the transaction target presented by each of buyers, first candidates to be plural candidates for combinations of the sellers and the buyers establishing valid transactions of the transaction target; and selecting plural second candidates to be displayed from the first candidates based on similarity among the first candidates.

In one mode of the storage medium, there is provided a storage medium storing a program executed by a computer, the program causing the computer to function as: a first candidate determination means configured to determine, based on seller information indicating a sale condition of a transaction target presented by each of sellers and buyer information indicating a buy condition of the transaction target presented by each of buyers, first candidates to be plural candidates for combinations of the sellers and the buyers establishing valid transactions of the transaction target; and a second candidate selection means configured to select plural second candidates to be displayed from the first candidates based on similarity among the first candidates.

### Effect

An example advantage according to the present invention is to suitably determine candidates for combinations of sellers and buyers to be displayed.

### BRIEF DESCRIPTION OF THE DRAWINGS

FIG. 1 illustrates a configuration of an optimization system in a first example embodiment.

FIG. 2 illustrates a hardware configuration of an information processing device.

FIG. 3 illustrates an example of a data structure of seller information.

FIG. 4 illustrates an example of the data structure of buyer information.

FIG. 5 illustrates an example of the data structure of vessel information.

FIG. 6 illustrates an example of the data structure of port information.

FIG. 7 illustrates an example of a functional block of the information processing device.

FIG. 8 illustrates a simplified specific example of the process executed by a first candidate determination unit and a second candidate selection unit.

FIG. 9 illustrates a matrix representing probability distributions based on determinantal point processes.

FIG. 10 illustrates a matrix representing probability distributions based on determinantal point processes.

FIG. 11 illustrates a display example of a matching summary view.

FIG. 12 illustrates a display example of a matching detail view.

FIG. 13 is an example of a flowchart showing a processing procedure relating to the display process of second candidates in the first example embodiment.

FIG. 14 is an example of a flowchart showing a determination process of first candidates.

FIG. 15 illustrates the configuration of the optimization system in a second example embodiment.

FIG. 16 is a functional block diagram of the information processing device according to a third example embodiment.

FIG. 17 is an example of a flowchart showing a processing procedure executed by the information processing device in the third example embodiment.

### EXAMPLE EMBODIMENTS

Hereinafter, an example embodiment of an information processing device, a control method, and a storage medium will be described with reference to the drawings.

### First Example Embodiment

### (1) System Configuration

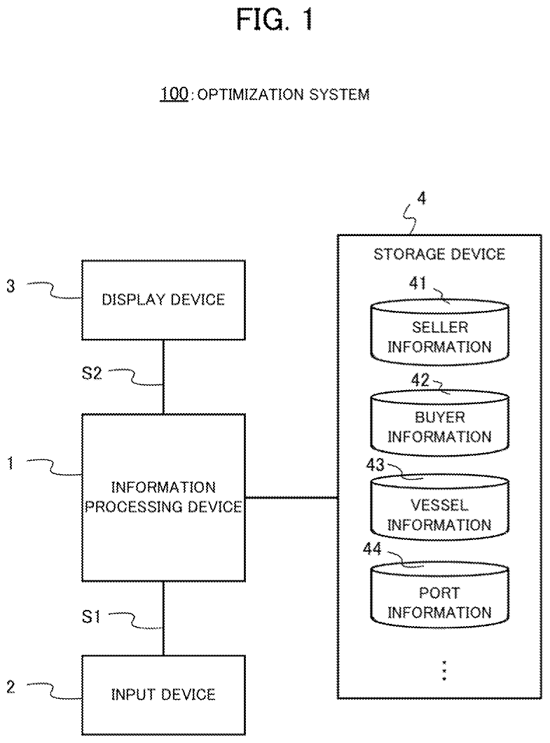

FIG. 1 shows the configuration of an optimization system 100 according to the first example embodiment. The optimization system 100 mainly includes an information processing device 1, an input device 2, a display device 3, and a storage device 4.

The information processing device 1 performs a process (simply referred to as “optimization process”) for determining the combinations of the sellers and the buyers of goods (commodity) to be traded and optimizing the transportation schedule of the goods. The information processing device 1 is preferably used by a trading company (firm) who mediates the purchase and sale of goods (transaction target) to be traded. Examples of the goods to be traded may include fuel such as LNG, steel, machinery, electronics, textiles, chemical products, medical-related goods, and foodstuffs. In the case that the goods to be traded are goods (e.g., LNG that evaporates over time) which cause the loss over time, it is necessary to smoothly transport goods from the seller to the buyer, and the need for optimization of the transport schedule becomes particularly high.

The information processing device 1 performs data communication with the input device 2, the display device 3, and the storage device 4 through a communication network or through direct wireless or wired communication.

The input device 2 is an interface that accepts the input by the user, and examples of the input device 2 include a touch panel, a button, a voice input device. The input device 2 supplies the input information “S1” generated based on the input by the user to the information processing device 1. In this case, for example, the information processing device 1 generates various kinds of information to be stored in the storage device 4 based on the input information S1 supplied from the input device 2, and specifies conditions or the like designated by the user with respect to the optimization process.

The display device 3 displays information based on the display information “S2” supplied from the information processing device 1, and examples of the display device 3 include a display and a projector.

The storage device 4 is a memory for storing various kinds of information necessary for the optimization process. The storage device 4 may be an external storage device such as a hard disk connected to or built in to the information processing device 1, or may be a storage medium such as a flash memory. The storage device 4 may be a server device that performs data communication with the information processing device 1. In this case, the storage device 4 may be configured by a plurality of server devices.

The storage device 4 stores seller information 41, buyer information 42, vessel information 43, and port information 44. The seller information 41 is information relating to the sellers of the goods to be traded via the user of the information processing device 1. The buyer information 42 is information relating to the buyers of goods to be traded through the user of the information processing device 1. The vessel information 43 is information relating to vessels which can be used to transport the goods to be traded by the mediator (e.g., trading company) that is the user of the information processing device 1. The port information 44 refers to information on ports (ports of loading or ports of discharge) to be used for transporting goods subject to transaction.

In addition to the information described above, the storage device 4 may store various kinds of information necessary for the optimization process. For example, the storage device 4 may further store information necessary for calculating the price of the goods to be traded, and the like. Further, the seller information 41, the buyer information 42, the vessel information 43, and the port information 44 may be generated by a device other than the information processing device 1 in advance, or may be information which the information processing device 1 generates and/or updates based on the input information outputted from the input device 2.

In some embodiments, the storage device 4 may store information regarding the loss with respect to the goods that deteriorate over time. In this case, for example, the information regarding the loss may be information on the amount of loss per unit time that is caused by the deterioration of the goods to be traded over time, or may be information indicating the ratio of decrease in the amount of the goods per unit time.

The configuration of the optimization system 100 shown in FIG. 1 is an example, various changes may be applied to the above configuration. For example, the input device 2 and the display device 3 may be integrated into one device. In this case, the input device 2 and the display device 3 may be configured as a tablet terminal integral with or separate from the information processing device 1. Further, the information processing device 1 may be configured by a plurality of devices. In this case, the plurality of devices functioning the information processing device 1 perform the transmission and reception of information necessary for executing the pre-allocated processing among these devices.

### (2) Hardware Configuration of Information Processing Device

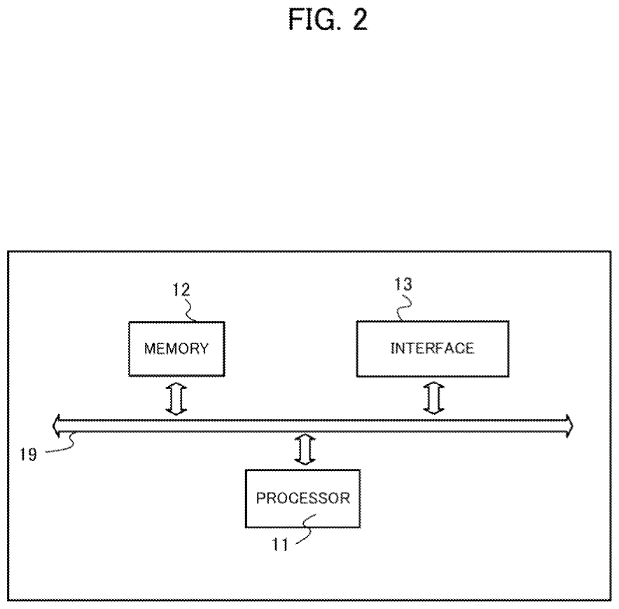

FIG. 2 shows the hardware configuration of the information processing device 1. The information processing device 1 includes a processor 11, a memory 12, and an interface 13 as hardware. The processor 11, the memory 12, and the interface 13 are connected to one another via a data bus 19.

The processor 11 executes a predetermined process by executing a program stored in the memory 12. The processor 11 is one or more processors such as a CPU (Central Processing Unit) and a GPU (Graphics Processing Unit).

The memory 12 is configured by various volatile memories and non-volatile memories such as a RAM (Random Access Memory) and a ROM (Read Only Memory). In addition, a program for executing an optimization process executed by the information processing device 1 is stored in the memory 12. The memory 12 is used as a work memory and temporarily stores information acquired from the storage device 4. The memory 12 may function as a storage device 4. Similarly, the storage device 4 may function as a memory 12 of the information processing device 1. The program executed by the information processing device 1 may be stored in a storage medium other than the memory 12.

The interface 13 is an interface for electrically connecting the information processing device 1 and other devices. For example, the interface 13 includes an interface for connecting the information processing device 1 and the input device 2, an interface for connecting the information processing device 1 and the display device 3, and an interface for connecting the information processing device 1 and the storage device 4. For example, the interface for connecting the information processing device 1 and the storage device 4 is a communication interface such as a network adapter for wired or wireless transmission and reception of data to and from the storage device 4 under the control of the processor 11. In another example, the information processing device 1 and the storage device 4 may be connected by a cable or the like. In this case, the interface 13 includes an interface which conforms to USB (Universal Serial Bus), SATA (Serial AT Attachment) or the like for exchanging data with the storage device 4.

The hardware configuration of the information processing device 1 is not limited to the configuration shown in FIG. 2. For example, the information processing device 1 may include at least one of an input device 2 or a display device 3. Further, the information processing device 1 may be connected to or incorporate a sound output device such as a speaker.

### (3) Data Structure

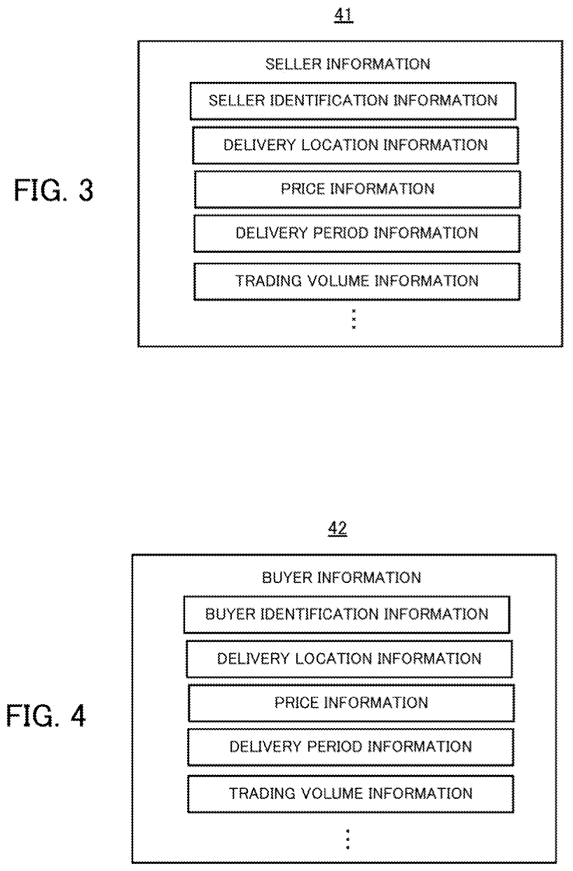

Next, an example of a data structure of various kinds of information stored in the storage device 4 will be described with reference to FIGS. 3 to 6.

FIG. 3 is an example of the data structure of seller information 41. The seller information 41 is information generated for each of the sellers of goods to be traded, and is information indicating the sell conditions (i.e., the terms of transaction desired by each seller) presented by each seller. Specifically, seller information 41 includes seller identification information, delivery location information, price information, delivery period information, loading port information, and trading volume information. Incidentally, the seller information 41 may be information indicating a table or a list having a record with respect to each seller.

The “seller identification information” is information that identifies each seller of goods to be traded. The seller identification information may include information on the attributes of each seller, such as the company name and location of each seller, in addition to the peculiar ID (seller ID) identifying each seller.

The “delivery location information” is information on the delivery location of the transaction target desired by each seller. For example, the delivery location information includes information indicating whether the delivery location is a port of loading or a port of discharge, and information regarding the port to be the delivery location.

The “price information” is information that indicates the price of goods to be traded desired by each seller. The “delivery period information” is information indicating the delivery period of the goods to be traded desired by each seller. The delivery period is generally set to a longer period as the schedule to delivery is ahead, and is determined in detail as it approaches the timing of delivery.

The “trading volume information” is information indicating the trading volume of goods desired by each seller. For example, the trading volume information is information indicating the lower limit and the upper limit of the trading volume of the goods desired by each seller, respectively. It is noted that when the goods to be traded is fuel, the trading amount is the amount of heat.

FIG. 4 is an example of the data structure of the buyer information 42. The buyer information 42 is information generated for each of the buyers of goods to be traded and indicates the buy conditions (i.e., the terms of purchase desired by each buyer) presented by each buyer. Specifically, the buyer information 42 includes buyer identification information, delivery location information, price information, delivery period information, discharging port information, and trading volume information. The buyer information 42 may be information indicating a table or a list having a record with respect to each buyer.

The “buyer identification information” is information that identifies each buyer of goods to be traded. The buyer identification information may include information on the attributes of each buyer, such as the company name and location of each buyer, in addition to the peculiar ID (buyer ID) identifying each buyer.

The “delivery location information” is information on the location of delivery of the transaction target desired by each buyer. For example, the delivery location information includes information indicating whether the delivery location is a port of loading or a port of discharge, and information regarding the port to be the delivery location.

The “price information” is information that indicates the price of goods to be traded desired by each buyer. The “delivery period information” is information indicating the delivery period of goods to be traded desired by each buyer. The delivery period is generally set to a longer period as the schedule to delivery is ahead, and is determined in detail as it approaches the timing of delivery.

The “trading volume information” is information that indicates the volume of traded goods desired by the target buyer. For example, the volume information is information indicating the lower limit and the upper limit of the trading volume of goods desired by the target buyer, respectively.

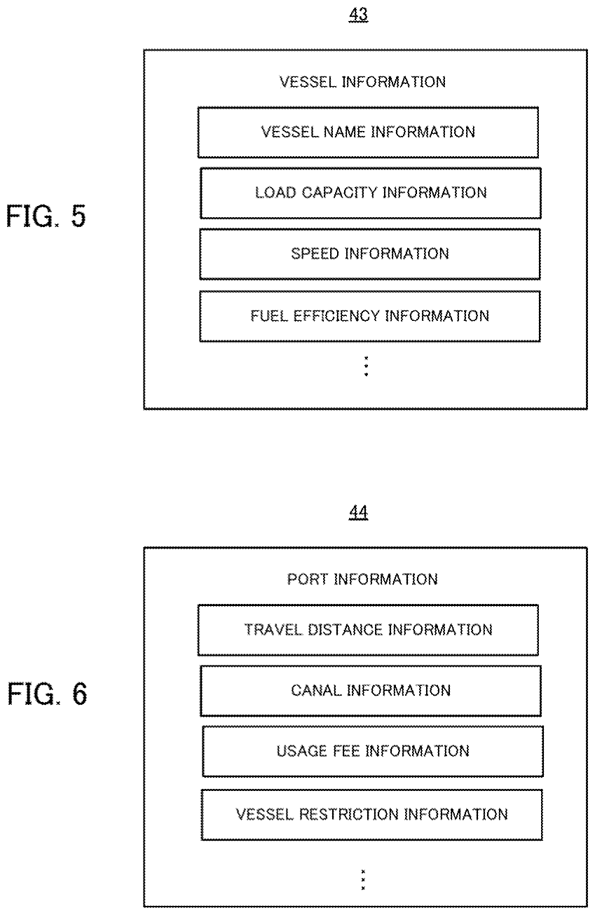

FIG. 5 is an example of the data structure of the vessel information 43. The vessel information 43 is information generated for each of the vessels that the user of the information processing device 1 can use, and mainly includes vessel name information, load capacity (burden) information, speed information, and fuel efficiency information. The vessel information 43 may be information indicating a table or a list having a record with respect to each vessel. Examples of transport information include the vessel information 43 and the port information 44 to be described later.

The “vessel name information” is information indicating the name of each vessel. The “load capacity information” is information that indicates the amount of goods that each vessel can load. The “speed information” is information on the speed of each vessel (e.g., maximum speed and average speed). The “fuel efficiency information” is information on the fuel efficiency of each vessel. In some embodiments, the fuel efficiency information is information indicating the fuel efficiency of each vessel in accordance with the speed.

It is noted that the vessel information 43 may be information on vessels (chartered vessels) which can be borrowed in a short term by the user of the information processing device 1. In this case, the vessel information 43 may further include information on the cost of the chartered vessel (such as the chartered cost per day, the fixed cost of the chartered vessel). The vessel information 43 may also further include information on the category of each vessel, information on the size of each vessel, and the like.

FIG. 6 is an example of the data structure of the port information 44. The port information 44 is information regarding a port that is a candidate for a port of loading or a port of discharge, including travel distance information, canal information, usage fee information, and vessel restriction information.

The “travel distance information” is information indicating the travel distance between ports. The travel distance information is, for example, a table information indicating the travel distance from a port of loading to a port of discharge with respect to each possible combination of a candidate port of loading and a candidate port of discharge.

The “canal information” is information that indicates the canals (e.g., Panama Canal and Suez Canal) where a toll to pass when traveling between ports occurs. The canal information is, for example, a table information indicating the canal to pass when moving from a port of loading to a port of discharge with respect to each possible combination of a candidate port of loading and a candidate port of discharge.

The “usage fee information” is information indicating a usage fee for each port. The usage fee information may also include information on the toll of the canal where the toll occurs.

The “vessel restriction information” is information indicating vessels that are not permitted to use each port. For example, the vessel restriction information is a table information indicating, for each port, the presence or absence of restrictions for each of the vessels that the user of the information processing device 1 can use.

### (4) Functional Block

In summary, the information processing device 1 determines temporary candidates (also referred to as “first candidates C1”) for the combinations of sellers and buyers to establish transactions and a transportation schedule and then presents candidates (also referred to as “second candidates C2”) selected from the first candidates C1 to a user who is a mediator by the display device 3. The functional block of the information processing device 1 necessary for realizing this process will be described below.

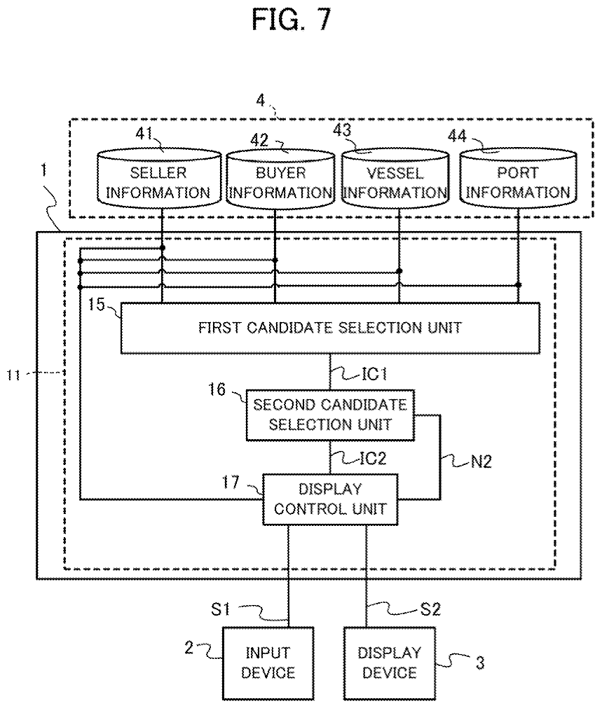

FIG. 7 is an example of a functional block of the information processing device 1 configured to execute the optimization process regarding the combination (matching) of the sellers and the buyers and the vessel transportation schedule. The processor 11 of the information processing device 1 functionally includes a first candidate determination unit 15, a second candidate selection unit 16, and a display control unit 17.

The first candidate determination unit 15 acquires, by referring to the storage device 4, the seller information 41 corresponding to a plurality of target sellers of matching. Further, the first candidate determination unit 15 acquires, by referring to the storage device 4, the buyer information 42 corresponding to a plurality of target buyers of matching. Further, the first candidate determination unit 15 acquires, by referring to the storage device 4, the vessel information 43 and the port information 44 which are the transport information on the goods to be traded. Then, based on the seller information 41, the buyer information 42, and the transport information, the first candidate determination unit 15 determines first candidates C1 each indicative of temporary combinations of the sellers and the buyers that establish the transactions and temporary transportation schedule. The first candidates C1 correspond to plural sets of combinations (matching) of sellers, buyers, and transportation means and function as the population from which second candidates C2 to be presented to the user are selected. The first candidate determination unit 15 determines “N1” first candidates C1 (i.e., N1 number of the first candidates C1) and supplies information (also referred to as “first candidate information IC1”) relating to N1 first candidates C1 to the second candidate selection unit 16. For example, the number N1 is stored in advance in the memory 12 or in the storage device 4, and is set to be the number sufficiently larger than the number thereof to be sampled from the first candidates C1 by the second candidate selection unit 16 so that the sampling process by the second candidate selection unit 16 to be described later can be executed.

On the basis of the similarity among the first candidates C1, the second candidate selection unit 16 selects candidates (also referred to as “second candidates C2”) for the combinations of the sellers and the buyers and the transportation schedule to be presented to the mediator who is a viewer from the N1 first candidates C1 indicated by the first candidate information IC1. In this case, the second candidate selection unit 16 selects “N2” second candidates C2 (i.e., N2 number of the second candidates C2) and information (also referred to as “second candidate information IC2”) indicative of the N2 second candidates C2 to the display control unit 17. Here, the number of candidates “N2” is two or more integer that is smaller than the number N1, and may be a number specified by the input information S1 (i.e., designated by the user input), or may be a number stored in advance in the memory 12 or in the storage device 4. As will be described later, the second candidate selection unit 16 selects the second candidates C2 by sampling using determinantal point processes in which a probability distribution is expressed by a matrix such that the lower the similarity among a set of the first candidates C1 is, the higher the possibility of selecting the set as the second candidates C2 becomes.

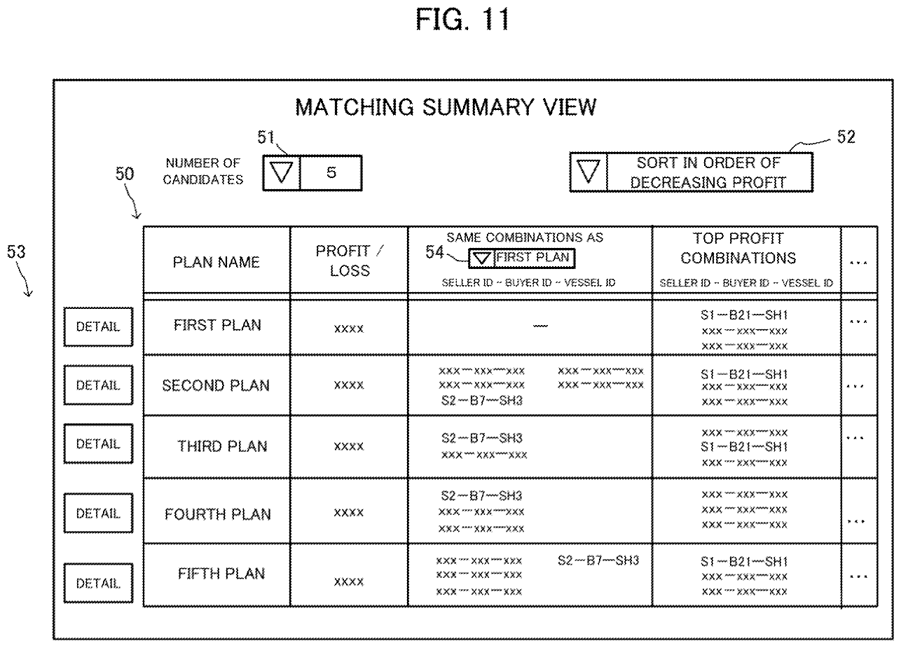

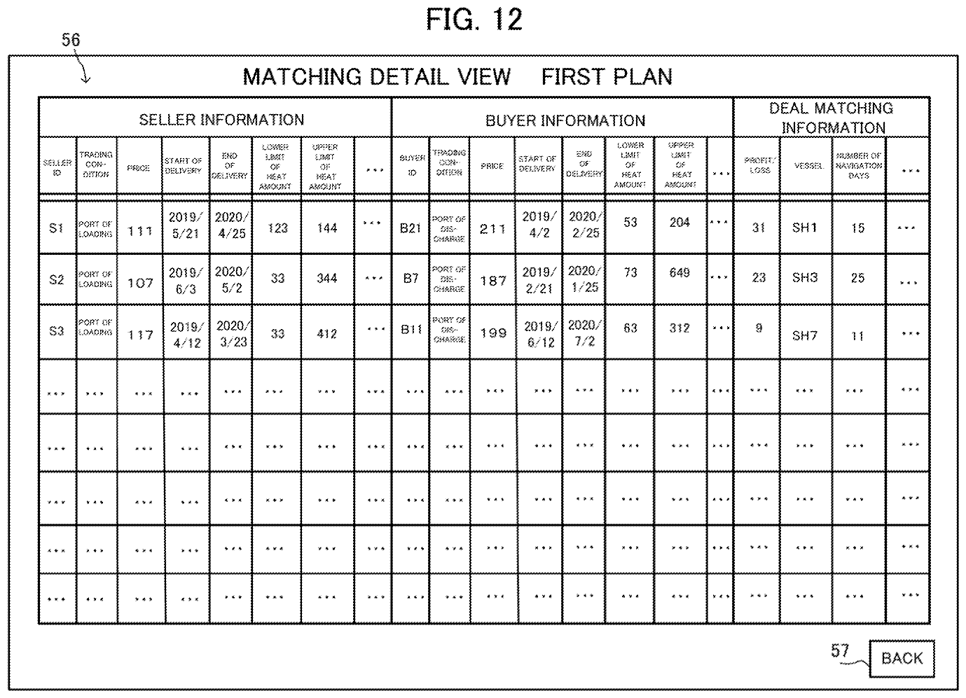

The display control unit 17 generates the display information S2 based on the second candidate information IC2 received from the second candidate selection unit 16 and various information stored in the storage device 4. Then, the display control unit 17 supplies the generated display information S2 to the display device 3 thereby to display the information relating to the second candidates C2 on the display device 3. The display example by the display device 3 based on the display information S2 will be described later with reference to FIGS. 11 and 12. Further, the display control unit 17 recognizes, based on the input information S1 (i.e., user input) supplied from the input device 2, the number N2 to be set that is the number of the second candidates C2, and notifies the second candidate selection unit 16 of the recognized number N2.

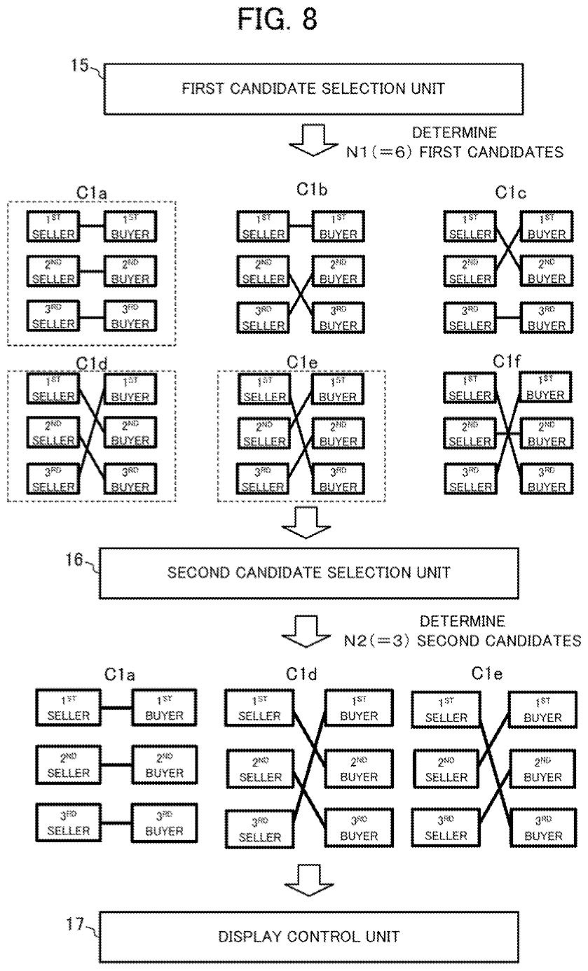

FIG. 8 shows a simplified specific example of the process executed by the first candidate determination unit 15 and the second candidate selection unit 16. In FIG. 8, for simplicity of explanation, it is assumed that there are three sellers (first seller to third seller) and three buyers (first buyer to third buyer) and the transportation schedule is not considered.

In this case, the first candidate determination unit 15 determines N1 first candidates C1. Here, the first candidate determination unit 15 determines the first candidates C1 to be each possible set of combinations of the sellers and the buyers. Specifically, the first candidate determination unit 15 generates six (i.e., N1=3!) first candidates “C1a” to “C1f” corresponding to the total number of possible sets of combinations of the sellers and the buyers. When considering the transportation schedule, the first candidate determination unit 15 further determines the transportation means (the vessel to be used) for transporting the transaction target for each pair of the seller and the buyer. Here, if we assume that there are three transportation means and that each of them can be assigned to any pair of the seller and the buyer, the number N1 of the first candidates will be 36 (N1=3!×3!).

In general, the number of sellers and buyers is larger than the number illustrated in FIG. 8 and the larger the number of sellers and buyers is, the larger the total number of possible sets of combinations of sellers and buyers becomes, which makes it difficult to determine the first candidates C1 corresponding to such a total number of possible sets of the combinations. Therefore, as will be described later, the first candidate determination unit 15 generates the predetermined number N1 of the first candidates C1 by repeatedly executing the combinatorial optimization.

Next, the second candidate selection unit 16 selects the second candidates C2 by performing sampling from the first candidates C1a to C1f in consideration of the similarity among them. Here, since the number N2 is set to “3”, the second candidate selection unit 16 selects three first candidates “C1a”, “C1d”, and “C1e” with low similarity to one another as the second candidates C2. Here, the first candidates C1a, C1d, and C1e selected as the second candidates C2 are sets of combinations of sellers and buyers, all of which have such a variety that there is no common combination (pair) of a seller and a buyer among them. The specific sampling method by the second candidate selection unit 16 will be described later. Then, the second candidate selection unit 16 supplies the display control unit 17 with the second candidate information IC2 indicating the selected second candidates C2 (i.e., the first candidate C1a, C1d, C1e). Thereafter, the display control unit 17 performs display control for presenting the second candidates C2 selected by the second candidate selection unit 16 to the user of the information processing device 1. Thus, the mediator, who is a user of the information processing device 1, can suitably grasp a variety of candidates of the combinations of the sellers and the buyers.

Each component of the first candidate determination unit 15, the second candidate selection unit 16, and the display control unit 17 described in FIGS. 7 and 8 can be realized, for example, by the processor 11 executing the program. More specifically, each component may be implemented by the processor 11 executing a program stored in the memory 12 or the storage device 4. In addition, the necessary programs may be recorded in any nonvolatile recording medium and installed as necessary to realize each component. Each of these components is not limited to being implemented by software using a program, and may be implemented by any combination of hardware, firmware, and software. Each of these components may also be implemented using user programmable integrated circuit, such as, for example, FPGA (field-programmable gate array) or a microcomputer. In this case, the integrated circuit may be used to realize a program to function as each of the above-described components. Thus, each component may be implemented by hardware other than the processor. The above is the same in other example embodiments to be described later.

### (5) Details of First Candidate Determination Unit

The first candidate determination unit 15 performs combinatorial optimization to maximize the profit of the user of the information processing device 1 while setting conditions relating to the trade of the transaction target as constraint conditions, based on the seller information 41, the buyer information 42, and the transport information. At this time, the first candidate determination unit 15 repeats the combinatorial optimization by applying feedback so as to generate a first candidate C1 different from the first candidate(s) C1 obtained by the already-executed combinatorial optimization. Thereby, the first candidate determination unit 15 generates N1 first candidates C1.

First, a specific example of the above-mentioned feedback is exemplified below. Specific approaches for the combinatorial optimization, which are performed repeatedly with feedback, will be described later.

In the first example, the first candidate determination unit 15 changes the weight parameters for pairs of the sellers and buyers whenever (each time) the combinatorial optimization is performed. For example, the first candidate determination unit 15 sets different weights for pairs of the sellers and the buyers, and randomly changes the weights within a preset value range each time combinatorial optimization is performed. Since the first candidate determination unit 15 actually executes the optimization of the transportation schedule, it may change and set the weights for each combination of the seller, the buyer, and the transportation means each time the combinatorial optimization is executed. Further, the first candidate determination unit 15 may lower the weight for at least a portion of the combinations obtained by the already-executed combinatorial optimization thereby to reduce the probability of establishing the same combinations in the next and subsequent combinatorial optimization.

In the second example, the first candidate determination unit 15 randomly changes (perturbs) the parameters indicating conditions (e.g., a unit price of the transaction target) relating to the trade of the transaction target every time combinatorial optimization is performed. In this case, the first candidate determination unit 15 may alleviate the constraint conditions, or may add a new constraint condition (e.g., prohibited use of a predetermined port). Further, the first candidate determination unit 15 may add a new constraint condition indicative of prohibiting obtaining the same solution as the already-obtained first candidates C1.

According to the first example and the second example described above, the first candidate determination unit 15 can suitably acquire the first candidates C1 which are different each time the combinatorial optimization is performed. It is noted that the first candidate determination unit 15 may determine the first candidates C1 by any method other than the first example and the second example described above. For example, when the number of the seller and the buyer to be combined is equal to or less than a predetermined number, the first candidate determination unit 15 may determine the first candidates C1 to be all possible sets of the combinations satisfying the constraint conditions as with the example shown in FIG. 8.

Next, a description will be given of a specific method of combinatorial optimization performed by the first candidate determination unit 15.

The first candidate determination unit 15 optimizes the combinations of the sellers and the buyers and the transportation schedule which establish valid transactions so that the profit of the user of the information processing device 1 is maximized while satisfying the constraint conditions for the deal of the transaction target. In this case, for example, the first candidate determination unit 15 considers a combinatorial optimization problem to determine the combinations of the sellers and the buyers and the transportation schedule to maximize the profit of the mediator and formulates it into an integer programming problem. In other words, the first candidate determination unit 15 formulates the combinations of the seller, the buyer, the vessels to be used, and the navigation period of the vessels as a combination optimization problem into an integer programming problem. The first candidate determination unit 15 obtains a solution on the formulated integer programming problem by performing a process equivalent to the process by a general application program (e.g., IBM ILOG CPLEX, Gurobi Optimizer, SCIP). Specifically, the first candidate determination unit 15 inputs constraints on the transactions and the transport in the form of linear integer constraints and a linear objective function that defines the profit to the above-described application program. Thereby, the first candidate determination unit 15 recognizes the transactions and the transport plan that maximizes the profit. In this case, the first candidate determination unit 15 also determines the delivery time and the trading volume and the like, at which the profit of the user is maximized. It is noted the assignment of vessels when transport is required can also be described as integer constraints.

In the above-described integer programming problem, the first candidate determination unit 15 sets the objective function representing the gross profit of the mediator and the linear integer constraints on the transactions and the transport based on the information on the price of the goods to be traded and the transportation date (the date of delivery).

Here, a description will be given of the conditions for the transactions and the transport, which are defined as linear integer constraints.

For example, the first candidate determination unit 15 determines a constraint condition for transactions to be a condition that the delivery period indicated by the delivery period information included in the seller information 41 is matched (consistent) with the delivery period indicated by the buyer information 42. In this case, if the goods to be traded are required to be transported, the first candidate determination unit 15 calculates the approximate number of navigation days taken to navigate from the port of loading designated by the seller to the port of discharge designated by the buyer, based on the vessel information 43 and the port information 44. The first candidate determination unit 15 determines whether or not it is possible to perform the delivery from the seller to the mediator (i.e., the user of the information processing device 1) during the delivery period designated by the seller and the delivery from the mediator to the buyer during the delivery period designated by the buyer, taking into consideration the calculated number of navigation days.

The number of navigation days indicating the length of the navigation period is the number of days required to move the vessel to the port of loading and the number of days required to transport the goods to be traded. Here, the first candidate determination unit 15 calculates the above-described number of days required for each vessel to undertake transactions based on, for example, the loading port information included in the seller information 41 and the discharging port information included in the buyer information 42, the travel distance information included in the port information 44, and the speed information included in the vessel information 43.

For example, the appropriate difference in the delivery period required for establishing the matching depending on the travel distance can be described in the form of linear integer constraints as follows.

Now, by use of integers S and B, it is assumed that there are S sellers and B buyers, and that the seller's index is “s=1, 2, . . . , S” and the buyer's index is “b=1, 2, . . . , B.” It is also assumed that x_{s, b} is a variable with a value of either 0 or 1, and x_{s, b}=1 means to sell what is sourced from the seller s to the buyer b. In this case, the one-to-one correspondence between the seller and the buyer can be expressed as follows.

For each s=1, 2, . . . , S,

$${\sum }_{{b}^{′} = 1}^{B} {x}_{s , {b}^{′}} = 1$$

For each b=1, 2, . . . , B,

$${\sum }_{{{{s}^{′} = 1}_{}}^{}}^{S} {x}_{{s}^{′} , b} = 1$$

Here, the purchase time from the seller s is expressed by the variable “tₛ”, and similarly, the delivery time to the buyer b is expressed by the variable “t_{b}”. In addition, the duration of transport from the seller s to the buyer b is indicated by “d_{s, b}”. At this time, by using a sufficiently large positive constant “M”, the constraint that the transportation time is guaranteed can be expressed as follows.

With respect to each s=1, 2, . . . , S and each b=1, 2, . . . , B,

t_{b}−tₛ≥d_{s,b}x_{s,b}−M(1−x_{s,b})

This formula is explained as follows. If it is not transported from the seller s to the buyer b, the equation “x_{s, b}=0” is satisfied. At this time, since M is sufficiently large, the following inequality is always true and thus the constraint is deactivated.

t_{b}−tₛ≥−M

On the other hand, the equation “x_{s, b}=1” is satisfied when it is transported from the seller s to the buyer b. At this time, the following constraint is required and this inequality means that a sufficient transit time is ensured.

t_{b}−tₛ≥d_{s,b}

Also, the constraint on the purchase (receipt) time tₛ from the seller can be expressed as follows.

T_{s,1}≤tₛ≤T_{s,2}

This means that the receiving time must be between the time “T_{s, 1}” and the time “T_{s, 2}”.

In addition, the first candidate determination unit 15 assigns a vessel to be used for each transaction and determines the navigation period so that the delivery of goods from the seller during the delivery period indicated by the delivery period information included in the seller information 41 and the delivery of goods to the buyer during the delivery period indicated by the delivery period information included in the buyer information 42 can be carried out. The assignment of vessels can be described in the form of linear integer constraints as follows.

Now, it is assumed that “v=1, 2, . . . , V” is the index of the vessel and the variable “y_{s, v}” is a variable that is either 0 or 1 for the seller “s=1, 2, . . . , S”. Also, “y_{s, v}=1” represents transactions with the seller s using the vessel v. At this time, the constraint of allocating one of the vessels to each transaction can be expressed as follows.

For each s=1, 2, . . . , S,

$${\sum }_{{v}^{′} = 1}^{V} {y}_{s , {v}^{′}} = 1$$

In addition, for each transaction of each seller s, “C(s)⊆{1, 2, . . . , S}” shall represent a seller who cannot transport goods by the same vessel as the vessel used in the transactions for the seller s. This means that, if the vessel v is allocated to the transactions of the seller s, the vessel v cannot arrive in time to the trading time of the other seller “s∈C(s)” included in C(s). At this time, such a constraint that the assignment of vessels does not collide among the transactions of multiple sellers can be expressed as follows using a sufficiently large positive constant M.

With respect to each s=1, 2, . . . , S and each v=1, 2, . . . , V,

$${\sum }_{{s}^{′} ∈ C ( s )} {y}_{{s}^{′} , v} \leq M ( 1 - {y}_{s , v} )$$

This constraint is explained as follows. If y_{s, v}=0 is satisfied and the vessel v is not assigned to the transactions of the seller s, the constraint is invalid because M is large enough. On the other hand, if y_{s, v}=1 is satisfied and the vessel v is assigned to the transactions of the seller s, then “y_{s′, v}=0” must be satisfied for the transactions of the seller s′ contained in C(s), which means that the vessel v is not assigned to the transactions of the other seller “s′∈C(s)”.

The actual implementation method is not limited to the above example. For example, while the above example deals with a case where the travel time is fixed and known in advance, constraints in the case where the speed of the vessel can be adjusted can be expressed in the same manner. Although the description was given of such an example that the collision of vessel assignments is expressed only by allocations to sellers, the constraints for cases where both sellers and buyers are affected by the collision of vessel assignments can also be described.

Further, for example, the first candidate determination unit 15 makes it a constraint condition of the transactions that the range of the trading volume indicated by the trading volume information included in the seller information 41 overlaps with the range of the trading volume indicated by the trading volume information included in the buyer information 42.

Further, for example, the first candidate determination unit 15 makes it a constraint condition of the transactions that the price (i.e., the desired sale value) desired by the seller and the price (i.e., the desired purchase value) desired by the buyer satisfies a predetermined relation. In this case, for example, the above-described relation may be expressed by an expression or an inequality that defines that the desired sale value is within a predetermined ratio of the desired purchase value. In this case, for example, the first candidate determination unit 15 may determine the transaction price to be an intermediate value between the desired sale value and the desired purchase value, or may determine the transaction price based on a predetermined formula with the desired sale value and the desired purchase value determined in advance.

In addition to or in place of the above-described conditions, the first candidate determination unit 15 may be set linear integer constraints for various conditions necessary for establishing the transactions of the trading target.

Next, a supplemental description will be given of the profit of the user of the information processing device 1 that is a mediator, which is set as an objective function in the above-mentioned integer programming problem. For example, a predetermined percentage of the total amount of the transaction value is generated as the profit of the mediator. In addition, as will be described later, in the case of transactions involving transport by the mediator, the amount corresponding to the fixed fee or the transport fee arises as the profit of the mediator. Therefore, when the combinations of the sellers and the buyers are determined, it is possible to determine the predicted value of the user's profit based on the transaction value. Accordingly, the first candidate determination unit 15 solves the above-described combinatorial optimization problem so that the predicted value of the profit of the mediator computed in this manner is maximized. The profit of the mediator can typically be formulated as the gross sales price minus the gross purchase price and transportation costs. Further, the first candidate determination unit 15 may determine the predicted value of the far-future profit (e.g., the predicted value of the profit at the time after a predetermined period or more) of the user by multiplying it by a decay rate that is less than 1.

For example, in the above-mentioned example, when the profit “p_{s, b}” of the delivery from the seller s to the buyer b and the cost “c_{s, v}” of the vessel v for the delivery from the seller s are given in advance, the gross profit (equal to the profit minus the cost of the transactions) can be expressed as follows.

$${{\sum }^{S}}_{s = 1} {{\sum }^{B}}_{b = 1} {p}_{s , b} {x}_{s , b} - {{\sum }^{S}}_{s = 1} {{\sum }^{V}}_{v = 1} {c}_{s , v} {y}_{s , v}$$

By solving an integer programming problem, whose objective function is the above equation, based on linear constraints under the above constraints, a transportation schedule that maximizes the profit is calculated.

The above explanation is just an example, and the implementation is not limited thereto. For example, transport costs may include a variety of things, such as port usage costs and fuel costs, and may be rewritten in a manner that relies on buyers as well.

Further, the first candidate determination unit 15 may determine the transport schedule to maximize the profit of the user of the information processing device 1 in further consideration of the delivery location information included in the seller information 41, the delivery location information included in the buyer information 42, the travel distance information included in the port information 44, and the fuel efficiency information for each speed included in the vessel information 43. Thus, for example, the first candidate determination unit 15 determines a long navigation period so as to prioritize fuel efficiency over speed in such transactions that there is a relatively large margin in the schedule of the vessel (i.e., the number of navigation days can be longer). Thereby, it is possible to increase the profit of the user of the information processing device 1. On the other hand, the first candidate determination unit 15 shortens the navigation period by giving priority to shortening the number of navigation days rather than the fuel efficiency in such transactions that there is relatively little margin in the schedule of the vessel (i.e., when transaction using the target vessel are consecutive, and the like).

In addition, when goods that causes a loss with time is to be traded, the first candidate determination unit 15 acquires from the storage device 4 information on the amount of loss over the lapse of time regarding the goods in units of time, and determines a transportation schedule in further consideration of the information to maximize the profit of the user of the information processing device 1. Thereby, the first candidate determination unit 15 can determine the transportation schedule so that the profit of the user of the information processing device 1 is maximized even when goods such as LNG which is supposed to be reduced due to evaporation are to be traded.

Then, the first candidate determination unit 15 sets, as one first candidate C1, a set of the combinations of the sellers and the buyers and the schedule of each vessel which are determined by the combinatorial optimization described above. Then, the first candidate determination unit 15 repeatedly performs the above-described combinatorial optimization with feedback to generate N1 first candidates C1 and supply the first candidate information IC1 indicating generated N1 first candidates C1 to the second candidate selection unit 16. The first candidate information IC1 may include, for example, information on the profit/loss of the user of the information processing device 1 obtained by combinatorial optimization.

Here, a supplementary explanation will be given for the case where the number of buyers does not coincide with the number of sellers. In this case, for example, the first candidate determination unit 15 may generate temporary seller information (also referred to as “temporary seller information”) or temporary buyer information (also referred to as “temporary buyer information”). Specifically, when the number of sellers is less than the number of buyers, the first candidate determination unit 15 generates one or more pieces, according to the number of shortages of the sellers, of temporary seller information indicating typical (representative) transaction conditions (regarding price, delivery location, delivery period, trading volume, etc.,) to be offered by a seller. Similarly, when the number of buyers is less than the number of sellers, the first candidate determination unit 15 generates one or more pieces, according to the number of shortages of the buyers, temporary buyer information indicating the typical (representative) transaction conditions (regarding price, delivery location, delivery period, trading volume, etc.,) to be offered by a buyer. It is noted that the delivery period indicated by the temporary seller information and the temporary buyer information may be set to be long enough to facilitate matching of the buyers and sellers. The temporary seller information and the temporary buyer information may be stored in advance in the storage device 4. In this case, for example, based on the matching result using the temporary seller information and the temporary buyer information, the user of the information processing device 1 can use the matching result as a guideline regarding whether or not to procure additional transaction partners.

### (6) Details of Second Candidate Selection Unit

The second candidate selection unit 16 selects N2 second candidates C2 to be displayed from N1 first candidates C1 based on the similarity among the first candidates C1 determined by the first candidate determination unit 15. Specifically, the second candidate selection unit 16 performs sampling of the second candidates C2 such that a group of any N2 first candidates C1 having lower similarity to one another is more likely to be selected as the N2 second candidates C2. Hereafter, a group of any N2 first candidates C1 is referred to as “first candidate group”.

Here, as an example of sampling of the second candidates C2, a description will be given of a sampling technique using determinantal point processes (DPP: Determinantal Point Processes). According to DPP, the probability distributions corresponding to 2^{N1} subsets based on N1 first candidates C1 can be represented by a N1×N1 matrix. Then, in the DPP, the determinant calculated from the elements of the above matrix, each corresponding to an element (i.e., each first candidate C1) of a subset, indicates the probability that the subset is sampled. According to the DPP, the degree of ease (degree of ease of selection) that each first candidate C1 is selected as a second candidate C2 is indicated by the corresponding diagonal element of the matrix, and the degree of difficulty in achieving compatibility among the first candidates C1 (i.e., the degree of difficulty in simultaneous selection as the second candidates C2) is indicated by the corresponding off-diagonal elements of the matrix.

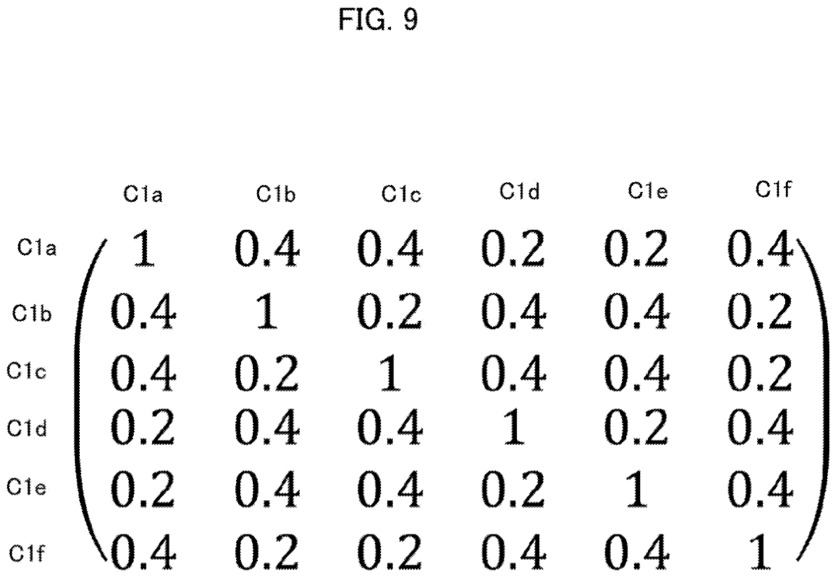

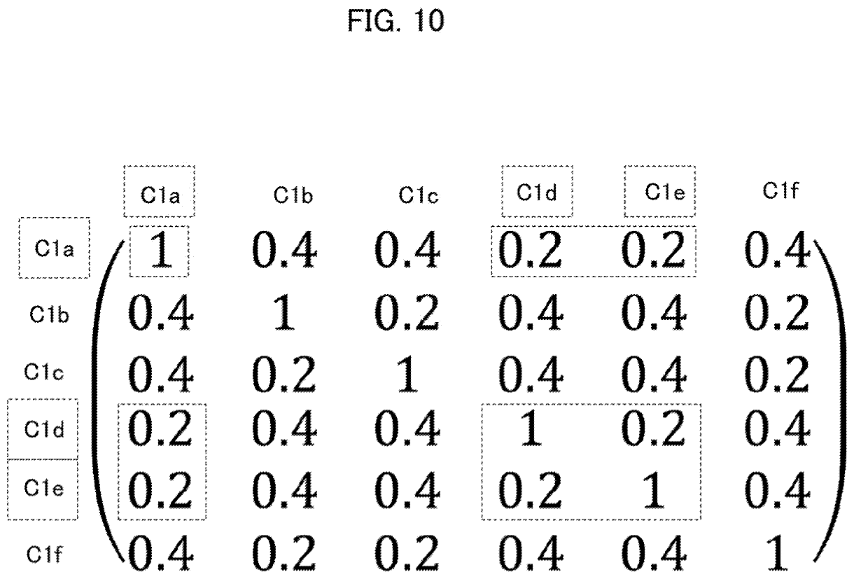

Here, a specific example of generating a N1×N1 matrix representing DPP from N1 first candidates C1 determined by the first candidate determination unit 15 will be described with reference to FIG. 9. FIG. 9 shows a matrix of DPP-based probability distributions corresponding to the six first candidates C1 (C1a to C1f) illustrated in FIG. 8. In FIG. 9, the first field and the first row correspond to the first candidate C1a, the second field and the second row correspond to the first candidate C1b, the third field and the third row correspond to the first candidate C1c. Further, the fourth field and the fourth row corresponds to the first candidate C1d, the fifth field and the fifth row correspond to the first candidate C1e, the sixth field and the sixth row correspond to the first candidate C1f.

First, the method of setting the diagonal elements of the matrix will be described. The second candidate selection unit 16 determines each diagonal element of the DPP to be individual selection easiness (i.e., selection easiness without considering the similarity among the first candidates C1) that the corresponding first candidate C1 determined by the first candidate determination unit 15 is selected as a second candidate C2. In FIG. 9, as an example, the second candidate selection unit 16 determines that the degrees of ease of selection of the first candidate C1a to the first candidate C1f individual are equal and therefore sets each diagonal element of the matrix to “1”.

In some embodiments, the second candidate selection unit 16 sets the individual degree of ease of selection of each first candidate C1 calculated by the first candidate determination unit 15, based on the profit of the mediator to be obtained in the case of the each first candidate C1. Specifically, the second candidate selection unit 16 increases the diagonal element of the matrix corresponding to the individual ease of selection of each first candidate C1 with increasing profit of the mediator to be obtained when the each first candidate C1 is adopted. For example, it is herein assumed that the profit of the mediator to be obtained in the case that any of the first candidates C1a to C1 is adopted as a “size 1” set (i.e., taken as a single element) is “X” times larger than the profit of the mediator to be obtained in the case that any of the first candidates C1d to C1f is adopted as a “size 1” set. In this case, the second candidate selection unit 16 sets the diagonal elements (the diagonal elements in the first to third fields and rows) corresponding to the first candidates C1a to C1c to a value X times larger than the diagonal elements (the diagonal elements in the fourth to sixth fields and rows) corresponding to the first candidates C1d to C1f. In this way, the second candidate selection unit 16 increases the diagonal elements of the matrix with increasing profit of the mediator in the case of adopting the corresponding first candidate C1. Thus, the second candidate selection unit 16 can suitably determine the probability distributions so that a first candidate C1 causing a high profit of the mediator is likely to be selected as a second candidate C2.

Next, a method for setting off-diagonal elements of the matrix will be described. The second candidate selection unit 16 determines an off-diagonal element of the DPP to be the difficulty (i.e., difficulty to achieve compatibility) that the corresponding two first candidates C1 are selected together as second candidates C2. In this case, the second candidate selection unit 16 determines the off-diagonal element of the matrix based on the similarity degree between the corresponding two first candidates C1. Here, the second candidate selection unit 16 calculates, as an index representing the similarity between the two first candidates C1, the number (also referred to as “recombination number Nc”) of recombination operations necessary to match the combinations of the sellers and the buyers (and the transport means) of the two first candidates C1.

It is noted that the above-described recombination operation refers to the operation of interchanging either of any two sellers or two buyers (or two transport means). For example, since the matching of the first candidate C1a and the first candidate C1b shown in FIG. 8 needs only one recombination operation that replaces “second seller” with “third seller” (or “second buyer” with “third buyer”), the required recombination number Nc is one. On the other hand, since the matching of the first candidate C1 a and the first candidate C1d needs two recombination operations (e.g., replacement of “first seller” with “third seller” and replacement of “second seller” with “third seller”), the required recombination number Nc is 2.

Then, the second candidate selection unit 16 determines each off-diagonal element of the matrix to be a value decreasing with increase in the number of recombination number Nc of the corresponding two first candidate C1. In the example of FIG. 9, the second candidate selection unit 16 calculates each off-diagonal element of the matrix, based on the following equation using recombination number Nc of the corresponding first candidates C1.

(3−Nc)×0.2

Thereby, the second candidate selection unit 16 can increase the degree of difficulty of selection of two first candidates C1 (i.e., make it difficult to be compatible) with increasing degree of similarity between the two first candidates C1, which enables N2 first candidates C1 having diversity to be selected as the second candidates C2. The values “3” and “0.2” shown in the above equation are stored in advance in the storage device 4 or the memory 12. In some embodiments, the second candidate selection unit 16 may change the value “3” in the above equation in accordance with the number of sellers (and buyers) so that each off-diagonal element is set to be a value greater than 0. For example, the second candidate selection unit 16 may use, in place of the value “3” in the above equation, a value larger by 1 than the maximum value of the recombination number Nc regardless of the number of seller (and buyer).

It is noted that the second candidate selection unit 16 may calculate, as an index of similarity between two first candidate C1, instead of the recombination number Nc, the number (also referred to as “matched combination number Ni”) of common (matched) combinations of sellers and buyers (and transport means) in the two first candidates C1. For example, in the case of the first candidate C1a and the first candidate C1b, since only the combination of “first seller” and “first buyer” is in common, the matched combination number Ni becomes “1”. On the other hand, in the case of the first candidate C1a and the first candidate C1d, since there is no pair of a seller and a buyer in common, the matched combination number Ni is “0”.

Then, the second candidate selection unit 16 determines each off-diagonal element of the matrix in DPP to be a value increasing with increasing matched combination number Ni of the corresponding two first candidate C1. For example, the second candidate selection unit 16 calculates each off-diagonal element of the matrix based on the following equation using the matched combination number Ni of the corresponding two first candidates C1.

0.1+Ni×0.2

In this case as well, the second candidate selection unit 16 can increase the degree of difficulty in selecting two first candidates C1 (i.e., makes it difficult to be compatible) with increasing degree of similarity between the two first candidates C1, and therefore can suitably select such a group of the first candidates having diversity as the second candidates C2. It is noted that the second candidate selection unit 16 may determine each off-diagonal element of the matrix using, in place of the matched combination number Ni, the number (also referred to as “different combination number Nd”) of different combinations of sellers and buyers (and transport means) in the two first candidates C1. In this case, the second candidate selection unit 16 may determine each off-diagonal element of the matrix by using the same equation as the equation to be used in the case of the recombination number Nc.

Then, the second candidate selection unit 16 generates a DPP matrix based on the first candidate information IC1 supplied from the first candidate determination unit 15, and performs sampling according to the probability distributions represented by the generated matrix. In this case, the matrix generated by the second candidate selection unit 16 has diagonal elements each set in accordance with the profit of the mediator to be obtained when each first candidate C1 is adopted, and has off-diagonal elements each set in accordance with the degree of similarity between the corresponding two first candidates C1. Thus, the second candidate selection unit 16 can suitably sample a group of the first candidates each causing a high profit of the mediator and having a low degree of similarity (high diversity) to one another as the second candidate C2.

When the sampling is performed according to DPP, since all sizes are the target of the sampling, the number of the first candidates C1 selected as the second candidates C2 is in the range from 0 to N1. Thus, the number N2 of the first candidates C1 is not necessarily selected by one sampling. In view of the above, for example, the second candidate selection unit 16 performs sampling according to k-DPP described in Non-Patent Literature 1 for sampling the specified number (here N2) of targets. Thus, the second candidate selection unit 16 can suitably select the first candidate group configured by N2 first candidates C1 as the second candidates C2.

In the following, the sampling based on k-DPP will be specifically described. First, a description will be given of the probability that the first candidate group configured by the number N2 of any first candidates C1 is selected as the second candidates C2 by the second candidate selection unit 16. Here, in the example shown in FIG. 8, a description will be given of the probability that the first candidate group configured by three first candidates C1a, C1d, and C1e is selected as the second candidates C2.

FIG. 10 illustrates a DPP matrix corresponding to the first candidates C1a to C1f in which elements related to the first candidates C1a, C1d, and C1e of interest are surrounded by broken line frame. In this case, first, the second candidate selection unit 16 calculates 3×3 determinant (also referred to as “target determinant”) including elements in the broken line frames related to the target first candidates C1a, C1d, C1e. Further, the second candidate selection unit 16 calculates the sum of 3×3 determinants (also referred to as “determinant sum”) of _{N1}C_{N2} (₆C₃=20 in this case) first candidate groups (i.e., all possible combinations when any N2 (3 in this case) first candidates C1 are selected from N1 (6 in this case) first candidates C1). The second candidate selection unit 16 sets the value obtained by dividing the target determinant by the determinant sum as the probability that the first candidate group configured by three first candidates C1a, C1d, and C1e is selected as the second candidate C2. The second candidate selection unit 16 executes the above-mentioned operation on each of _{N1}C_{N2} first candidate groups corresponding to all possible combinations of selected N2 first candidates C1. Thus, the second candidate selection unit 16 suitably sets the probability distributions of all the first candidate groups each of which is a candidate to be selected as the second candidates C2 thereby to select N2 second candidates C2 by one sampling. In practice, when the above-mentioned operations regarding the determinants are performed on _{N1}C_{N2} first candidate groups that are all possible combinations, it takes a calculation time according to the number of combinations and thus could deteriorate the efficiency of sampling that is one of the advantages of k-DPP. Therefore, for example, the second candidate selection unit 16 may execute k-DPP using an algorithm based on eigenvalues and eigenvectors as described in Non-Patent Literature 1.

It is noted that the second candidate selection unit 16 may perform sampling of N2 first candidates C1 according to a method other than k-DPP. For example, when the number of the first candidates C1 sampled by DPP is less than N2, the second candidate selection unit 16 repeats sampling by DPP until N2 or more are sampled. Further, the second candidate selection unit 16 may randomly extract N2 second candidates C2 from the sampled first candidates C1 when the number of first candidates C1 sampled by one or more sampling is more than N2.

### (7) Display Example

FIG. 11 is a display example of a matching summary view displayed by the display device 3 based on the display information S2 supplied from the display control unit 17 of the information processing device 1. The display control unit 17 displays a second candidate table 50, a candidate number specifying field 51, a sort selection field 52, and a detail button 53 on the matching summary view shown in FIG. 11.

The second candidate table 50 is a table including records respectively representing the second candidates C2 selected by the second candidate selection unit 16. The display control unit 17 displays the second candidate table 50 based on five (N2=5) second candidates C indicated by the second candidate information IC2 supplied from the second candidate selection unit 16. The second candidate table 50 mainly has items “plan name,” “profit/loss,” “same combinations as first plan”, and “top profit combinations”.

The item “plan name” indicates the name allocated to each second candidate C2, where the plan names of the “first plan” to the “fifth plan” are allocated in order from the second candidate C2 with top profit or loss indicated by the item “profit/loss”. The item “profit/loss” indicates the profit or loss of the mediator corresponding to each second candidate C2.

The item “same combinations as first plan” indicates, for each second candidate C2 corresponding to the second plan to the fifth plan other than the first plan, the same combination(s) of sellers, buyer, and vessels as the second candidate C2 corresponding to the first plan. The second candidate table 50 includes the selection field 54 for accepting an input for changing “first plan” in the item “same combination as first plan” to the other second candidate C2. Therefore, when the second candidate C2 other than the first plan is selected in the selection field 54, the display control unit 17 displays, in the target item, the same combinations of sellers, buyers, and vessels for each record other than the selected second candidate C2. The item “top profit combinations” indicates top profit combinations (in this case, first to third combinations) of the seller, buyer, and vessel for each second candidate C2.

The candidate number specifying field 51 is a field for specifying the number N2 of the second candidates C2 to be displayed on the second candidate table 50. The second candidate selection unit 16 selects the specified number (N2=5) of the second candidates C2 specified in the candidate number specifying field 51. Then, the display control unit 17 displays the second candidate table 50 including records corresponding respectively to the number N2 of the second candidates C2 selected by the second candidate selection unit 16. The sort selection field 52 is a field for specifying a type of the sorting method (sorting) of the records in the second candidate table 50. Here, since the item “sort in order of decreasing profit” is selected, the display control unit 17 displays the records of the second candidates C2 arranged in order of decreasing profit on the second candidate table 50. Each of the detailed buttons 53 is a button for instructing the detailed display of the corresponding second candidate C2 and is provided for each record of the second candidate table 50. When the display control unit 17 detects that any of the detailed buttons 53 is selected, the display control unit 17 generates display information S2 for displaying the matching detail view shown in FIG. 12 to be described later. Then, by supplying the display information S2 to the display device 3, the display control unit 17 displays the matching detail view on the display device 3.

FIG. 12 is a display example of a matching detail view displayed on the display device 3 based on the display information S2 supplied from the display control unit 17 of the information processing device 1. Here, the display control unit 17 detects that the detail button 53 corresponding to the first plan is selected in the matching summary view shown in FIG. 11, and displays the matching detail view showing the details of the matching result corresponding to the first plan on the display device 3. Here, as an example, the display control unit 17 displays on the display device 3 the matching detail view in the case where the transaction target is LNG. The matching detail view mainly includes a matching table 56 and a return button 57 for view transition to the matching summary view.

The matching table 56 mainly has each major item of “seller information”, “buyer information”, “deal matching information”. The major item “seller information” includes sub-items of “seller ID”, “trading condition”, “price”, “start of delivery”, “end of delivery”, “lower limit of heat amount”, and “upper limit of heat amount”. The major item “buyer information” includes sub-items of “buyer ID”, “trading condition”, “price”, “start of delivery”, “end of delivery”, “lower limit of heat amount”, and “upper limit of heat amount”. The major item “deal matching information” includes sub-items of “profit/loss”, “vessel” and “number of navigation days”.

Here, the display control unit 17 generates each record of the matching table 56, for each combination (pair) of the seller and the buyer determined by the first candidate determination unit 15, based on the corresponding seller information 41 and buyer information 42. For example, the display control unit 17 displays the seller ID indicated by the seller identification information included in the corresponding seller information 41 in the item “seller ID”. Further, the display control unit 17 displays, in the item “trading condition”, the information (herein, information indicating whether the delivery location is the port of loading or the port of discharge) indicative of the delivery location indicated by the delivery location information included in the seller information 41, and displays, in the item “price”, the price indicated by the price information included in the seller information 41. Further, the display control unit 17 displays, in the items “start of delivery” and “end of delivery”, the start and end of the delivery period indicated by the delivery period information included in the seller information 41, respectively. Further, the display control unit 17 displays, in the items “lower limit of heat amount” and “upper limit of heat amount”, the lower limit and the upper limit of the trading volume indicated by the trading volume information included in the seller information 41, respectively. The display control unit 17 displays the buyer ID indicated by the buyer identification information included in the corresponding buyer information 42 in the item “buyer ID”. Further, the display control unit 17 displays, in the item “trading condition”, the information (herein, information indicating whether the delivery location is the port of loading or the port of discharge) indicative of the delivery location indicated by the delivery location information included in the buyer information 42, and displays, in the item “price”, the price indicated by the price information included in the buyer information 42. Further, the display control unit 17 displays, in the items “start of delivery” and “end of delivery”, the start and end of the delivery period indicated by the delivery period information included in the buyer information 42, respectively. Further, the display control unit 17 displays, in the items “lower limit of heat amount” and “upper limit of heat amount”, the lower limit and the upper limit of the trading volume indicated by the trading volume information included in the buyer information 42, respectively.

Further, in addition to the information regarding the combinations of the sellers and the buyers, the display control unit 17 displays, in the item “deal matching information” with respect to each record in the matching table 56, the profit/loss and allocated vessels for the corresponding transactions. Specifically, the display control unit 17 displays, in the item of “profit/loss”, the profit or loss calculated by the first candidate determination unit 15 for each transaction (i.e., pair of a seller and a buyer). Further, on the basis of the vessel name information included in the vessel information 43, the display control unit 17 displays, in the item “vessel”, the identification information of the vessel allocated for each transaction by the first candidate determination unit 15. Further, the display control unit 17 displays, in the item “number of navigation days”, the number of navigation days that the first candidate determination unit 15 has determined for each transaction. Further, the display control unit 17 may further include, in the item “deal matching information”, the item indicating the trading volume (heat amount) when the profit of the user of the information processing device 1 is maximized, the item indicating the delivery timing regarding the seller and the delivery timing regarding the buyer when the profit of the user is maximized, respectively. Such information is generated in the optimization process by the first candidate determination unit 15 and is supplied to the display control unit 17.

In this way, the information processing device 1 can suitably present to the user the details of the combinations of the sellers and the buyers corresponding to the second candidate C2 selected by the user. Further, the information processing device 1 can suitably present to the user, together with the combinations of the sellers and the buyers, the information on the vessel assigned to each of the combinations.

Here, a supplementary description will be given of the effect of the above display example.

Since the second candidate selection unit 16 selects a plurality of the second candidates C2 having high diversity from the first candidates C1, the first plan to the fifth plan presented by the display control unit 17 to the mediator that is a viewer on the matching summary view in FIG. 11 are expected to have high diversity. Thus, the display control unit 17 suitably provides the mediator who is a viewer with multi-sided information for consideration regarding the matching, while preventing the complication of the display caused by presenting substantially the same second candidates C2. In addition, by comparing the second candidates with one another, the viewer can suitably make a draft of a new matching such as a draft to combine a good point of a second candidate C2 with another second candidate C2 and can suitably perform a study of negotiation for realizing a better matching. In addition, when the first candidate group with high diversity is presented as the second candidates C2, the viewer can multilaterally confirm whether or not the conditions to be considered in the real society are reflected, thereby obtaining a sense of security.

Further, by displaying the second candidate table 50 representing a plurality of second candidates C2 having high diversity on the matching summary view, display control unit 17 can suitably improving the interpretability (i.e., the degree of understanding on which matching is good) of the mediator as a viewer. For example, in the item “same combination as first plan” in FIG. 10, a combination (S2-B7-SH3) of the seller ID “S2”, the buyer ID “B7”, and the vessel ID “SH3” is included in all records. Thus, the mediator that is a viewer can suitably grasp that the combination of these seller, buyer, and vessel is a combination of a deal indispensable for good matching. In another example, a combination (S1-B21-SH1) of the seller ID “S1”, the buyer ID “B21” and the vessel ID “SH1” is recorded as a profitable trading combination in the first plan through the third plan and the fifth plan. Thus, the mediator who is a viewer can suitably grasp that such a combination of these seller, buyer, and vessel is a preferable trading combination to generate a profit.

### (8) Process Flow

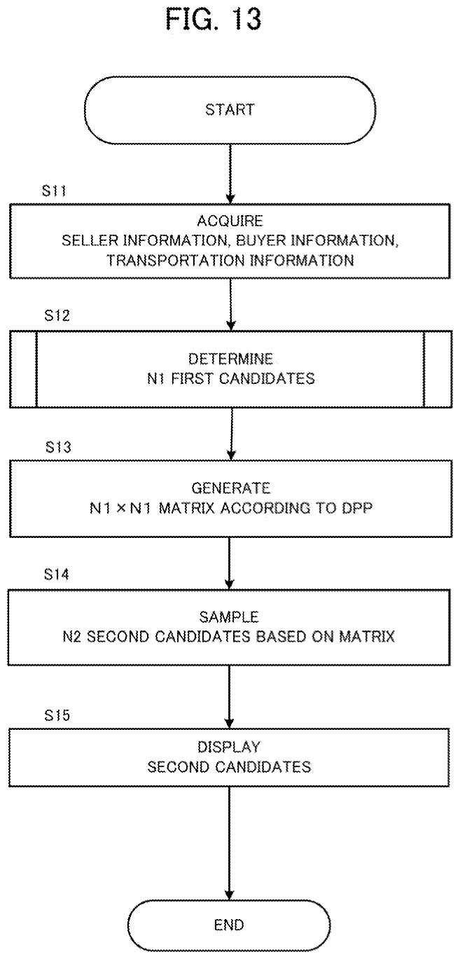

FIG. 13 is an example of a flowchart showing a processing procedure relating to the display process of the second candidates C2 to be executed by the information processing device 1 in the first example embodiment. The information processing device 1 executes the process of the flowchart shown in FIG. 13, for example, when the input information S1 requesting the display of the second candidates C2 is detected. The input information S1 requesting the display of the second candidate C2 may correspond to the display request of the matching summary view shown in FIG. 11 or may correspond to the change request of the number N2 of the second candidates C2 in response to the operation in the candidate number designation field 51 provided on the matching summary view.

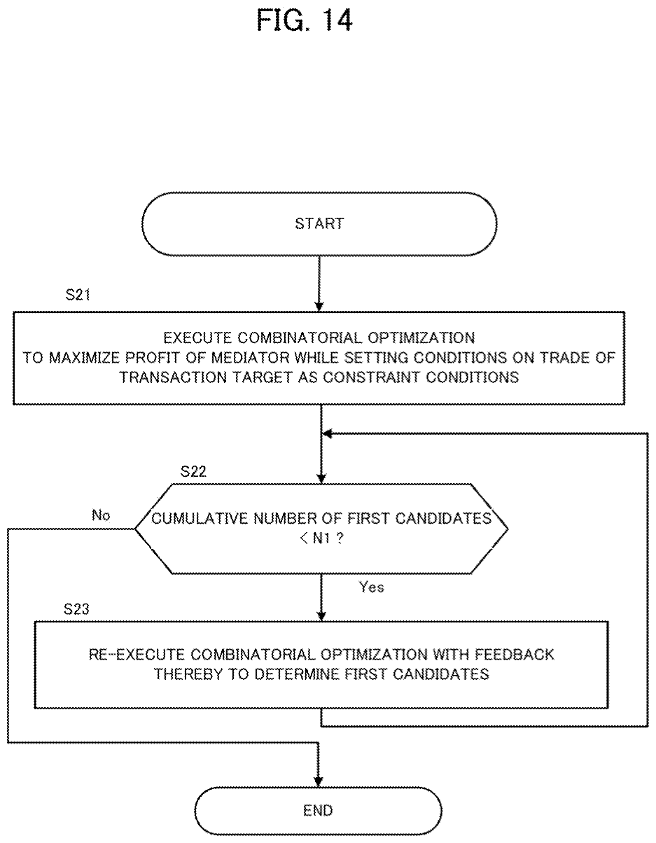

First, the first candidate determination unit 15 of the information processing device 1 acquires the seller information 41, the buyer information 42, and the transport information such as the vessel information 43 and the port information 44 from the storage device 4 through the interface 13 (step S11). Then, the first candidate determination unit 15 determines N1 first candidates C1 based on the various information acquired at step S11 (step S12). The specific process at step S12 will be described later with reference to FIG. 14.

Next, the second candidate selection unit 16 generates a N1×N1 matrix in determinantal point processes (DPP) (step S13). In this case, for example, the second candidate selection unit 16 sets each diagonal element of the matrix based on the profit of the mediator to be obtained when each first candidate C1 is adopted and set each off-diagonal element of the matrix based on the recombination number Nc or match combination number Ni between the corresponding two first candidates C1.

Then, the second candidate selection unit 16 performs sampling of N2 second candidates C2 according to the probability distributions indicated by the matrix set at step S13 from N1 first candidates C1 (step S14). In this case, the number N2 may be a predetermined number or may be set to a number specified based on the user input (e.g., the number specified in the candidate number designation field 51 of the matching summary view). Thus, the second candidate selection unit 16 selects N2 second candidates C2 each coming with a high profit of the mediator and a high diversity.

Then, the display control unit 17 displays N2 second candidates C2 selected by the second candidate selection unit 16 on the display device 3 (step S15). In this case, for example, the display control unit 17 generates display information S2 for displaying the matching summary view and supplies the display information S2 via the interface 13 to the display device 3 thereby to display the matching summary view on the display device 3. Thus, the display control unit 17 can suitably present N2 second candidates C2 with a high profit of the mediator and a high diversity to the user of the information processing device 1.

FIG. 14 is an example of a flowchart illustrating a determination process of the first candidates C1 at step S12.

First, based on the information obtained at step S11, the first candidate determination unit 15 executes a combinatorial optimization to maximize the profit of the mediator while setting conditions relating to the trade of the transaction target as constraint conditions (step S21). Thereby, the first candidate determination unit 15 acquires at least one first candidate C1.

Next, the first candidate determination unit 15 determines whether or not the cumulative number of the first candidates C1 determined at step S21 is less than N1 (step S22). When the cumulative number of the first candidate C1 determined at step S21 is less than N1 (step S22; Yes), the first candidate determination unit 15 re-executes the combinatorial optimization with feedback and determines one or more first candidates C1 that are different from the first candidates C1 obtained so far (step S23). In this case, for example, the first candidate determination unit 15 determines one or more first candidates C1 that are different from the determined first candidates C1 by re-executing the combinatorial optimization while changing the weights for the combinations of the sellers and the buyers (and the transportation means) or changing the constraint conditions. Thereafter, the first candidate determination unit 15 repeatedly executes the process at step S23 until the accumulated number of the calculated first candidates C1 reaches N1.

### (9) Modifications

Next, a description will be given of preferred modifications to the first example embodiment. The following modifications may be applied to the first example embodiment in arbitrary combination.

### First Modification

The information processing device 1 determined the transportation schedule on the assumption that a vessel is used as a transportation means. Alternatively, the information processing device 1 may determine the transport schedule of the transaction target by means of transportation means other than vessels (such as airplanes) or a combination of vessels with the other transportation means. In this case, the storage device 4 stores, in addition to or in place of the vessel information 43 and port information 44, information on other transportation means that can be used, information on ports (airports) used by other transportation means, and the like.

### Second Modification

The selection of the second candidates C2 by the second candidate selection unit 16 is not limited to sampling based on determinantal point processes.

For example, in some embodiments, the second candidate selection unit 16 determines the first candidate group configured by N2 first candidates C1 between any two of which the different combination number Nd or recombination number Nc is equal to or larger than a predetermined threshold value, and then determines the second candidates C2 to be the determined first candidate group. The above-described predetermined threshold value may be a value stored in the memory 12 or the storage device 4 in advance, or may be a value determined from the number of candidates N2 and the number of sellers and the number of buyers by referring to a predetermined look-up table. In another example, for each first candidate group corresponding to all _{N1}C_{N2} combinations of N2 first candidates C1 selected from N1 first candidates C1, the second candidate selection unit 16 calculates the sum of the different combination numbers Nd or the recombination numbers Nc of all possible pairs (i.e., _{N2}C₂ pairs in total) selected from the each first candidate group. Then, the second candidate selection unit 16 selects a first candidate group having the largest sum as the second candidates C2. Besides, by these methods, the second candidate selection unit 16 can suitably present the matching result with diversity to the user of the information processing device 1.

### Third Modification

The information processing device 1 may not execute the determination process of the transport schedule based on the vessel information 43 and the port information 44. In this case, the information processing device 1 determines the combinations of the sellers and the buyers as the first candidates C1 and the second candidates C2, respectively, based on the seller information 41 and the buyer information 42, without referring to the vessel information 43 and the port information 44.

### Second Example Embodiment

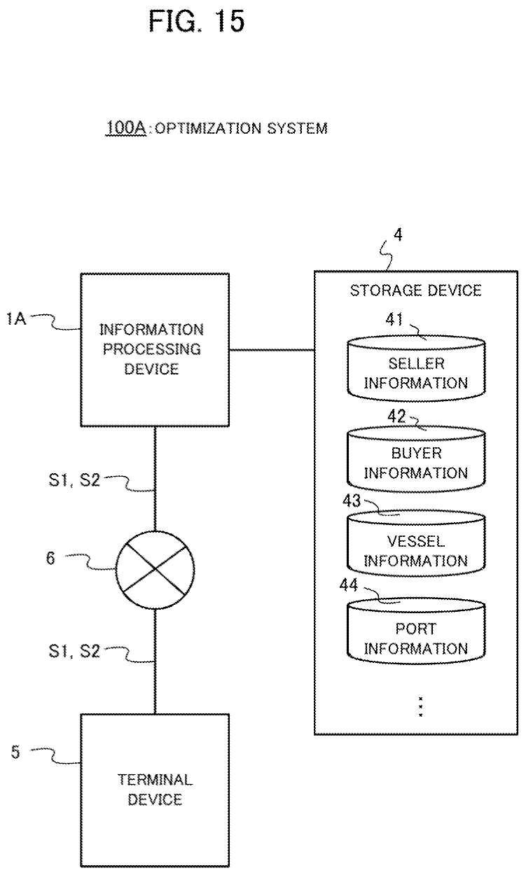

FIG. 15 shows a configuration of an optimization system 100A in the second example embodiment. As shown in FIG. 15, the optimization system 100A mainly includes an information processing device 1A, a storage device 4, and a terminal device 5. The information processing device 1A and the terminal device 5 perform data communication via the network 6 with each other.

The information processing device 1A has the same configuration as the information processing device 1 according to the first example embodiment and executes the same optimization process as the optimization process executed by the information processing device 1. In this case, the information processing device 1A receives the input information S1 from the terminal device 5 via the network 6 while the information processing device 1 in the first example embodiment receives the input information S1 from the input device 2. Further, the information processing device 1A transmits the display information S2 to the terminal device 5 via the network 6 while the information processing device 1 in the first example embodiment transmits the display information S2 to the display device 3. Accordingly, the information processing device 1A according to the second example embodiment functions as a server device.

The terminal device 5 is a terminal equipped with an input function, a display function, and a communication function, and functions as the input device 2 and the display device 3 in the first example embodiment. Examples of the terminal device 5 include a personal computer, a tablet-type terminal, and a PDA (Personal Digital Assistant). The terminal device 5 transmits the input information S1 generated based on the received user input to the information processing device 1A through the network 6. When receiving the display information S2 from the information processing device 1A, the terminal device 5 displays the matching summary view and the matching detail view based on the display information S2.

The information processing device 1A according to the second example embodiment can suitably present the contents to be displayed on the display device 3 in the first example embodiment to the user of the terminal device 5. Therefore, when the user of the terminal device 5 is a mediator, it is possible to suitably present to the user such matching results with high profit of the mediator and high diversity.

### Third Example Embodiment

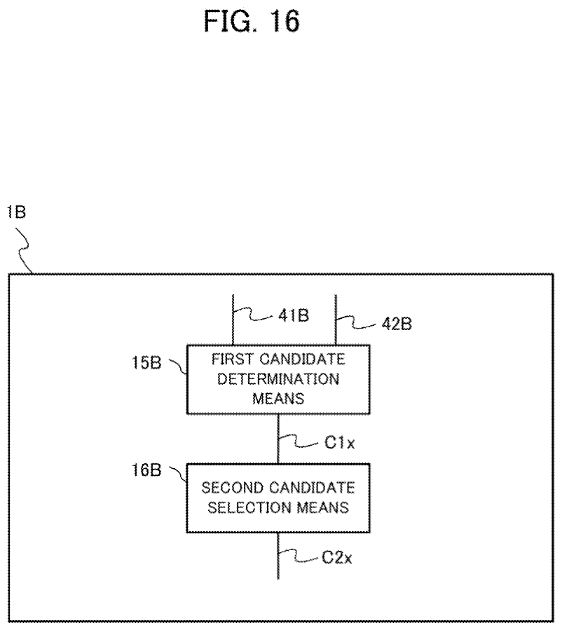

FIG. 16 is a functional block diagram of an information processing device 1B according to the third example embodiment. The information processing device 1B mainly includes a first candidate determination means 15B and a second candidate selection means 16B.

The first candidate determination means 15B is configured to determine, based on seller information “41B” indicating a sale condition of a transaction target presented by each of sellers and buyer information “42B” indicating a buy condition of the transaction target presented by each of buyers, first candidates “C1x” to be plural candidates for combinations of the sellers and the buyers establishing valid transactions of the transaction target. As with the first candidates C1 in the first or second example embodiment, each of the first candidates C1x may be a candidate that further considers combinations with transportation means such as a vessel to be used. Examples of the first candidate determination means 15B include the first candidate determination unit 15 in the first and second example embodiments.

The second candidate selection means 16B is configured to select plural second candidates “C2x” to be displayed from the first candidates C1x based on similarity among the first candidates C1x. In this case, examples of the second candidate selection means 16B include the second candidate selection unit 16 in the first or second example embodiment. The second candidates C2x may be displayed on the display device 3 in the first example embodiment, or may be displayed on the terminal device 5 in the second example embodiment.

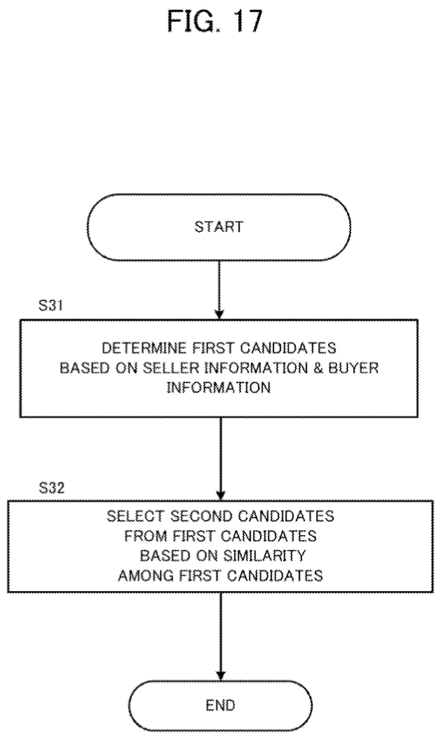

FIG. 17 is an example of a flowchart illustrating a processing procedure of an information processing device 1B according to the third example embodiment. First, the first candidate determination means 15B determines, based on the seller information 41B and the buyer information 42B, first candidates C1x to be plural candidates for combinations of the sellers and the buyers establishing valid transactions (step S31). Then, the second candidate selection means 16B selects plural second candidates C2x to be displayed from the first candidates C1x based on similarity among the first candidates C1x (step S32).

In such a case that there are plural sellers and plural buyers, the information processing device 1B according to the third example embodiment can suitably select a plurality of matching results to be presented to the user considering the similarity thereof.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

An information processing device comprising:

a first candidate determination means configured to determine,
based on seller information indicating a sale condition of a transaction target presented by each of sellers and buyer information indicating a buy condition of the transaction target presented by each of buyers,
first candidates to be plural candidates for combinations of the sellers and the buyers establishing valid transactions of the transaction target; and

a second candidate selection means configured to select plural second candidates to be displayed from the first candidates based on similarity among the first candidates.

[Supplementary Note 2]

The information processing device according to Supplementary Note 1,

wherein the second candidate selection means is configured to select the plural second candidates such that the lower the similarity among a set of first candidates is, the higher a possibility of selecting the set of the first candidates as the plural second candidates becomes.

[Supplementary Note 3]

The information processing device according to Supplementary Note 1 or 2,

wherein the second candidate selection means is configured to select the plural second candidates such that a possibility of selecting a first candidate as a second candidate increases with an increase in a profit of a mediator mediating the transactions of the transaction target to be obtained in case of the first candidate.

[Supplementary Note 4]

The information processing device according to any one of Supplementary Notes 1 to 3, wherein the second candidate selection means is configured to select the plural second candidates through a sampling using determinantal point processes in which probability distributions based on the similarity are represented by a matrix.

[Supplementary Note 5]

The information processing device according to any one of Supplementary Notes 1 to 4, wherein the second candidate selection means configured to selects a number of the second candidates from the first candidates,

the number being specified by a user input.

[Supplementary Note 6]

The information processing device according to any one of Supplementary Notes 1 to 5, wherein the first candidate determination means is configured to determine a predetermined number of the first candidates by executing plural number of combinatorial optimizations while changing conditions on each of the combinatorial optimizations,

each of the combinatorial optimizations determining the combinations of the sellers and the buyers to maximize a profit of a mediator mediating the transactions of the transaction target.

[Supplementary Note 7]

The information processing device according to any one of Supplementary Notes 1 to 6,

wherein the first candidate determination means is configured to determine,
based on the seller information, the buyer information, a profit of a mediator mediating the transactions of the transaction target, and transport information relating to transport of the transaction target from the sellers to the buyers,
a schedule of the transport for each of the first candidates.

[Supplementary Note 8]

The information processing device according to Supplementary Note 7,

wherein the second candidate selection means is configured to selects the plural second candidates based on the similarity among the first candidates that are candidates for combinations of the sellers, the buyers, and means of the transport.

[Supplementary Note 9]

The information processing device according to any one of Supplementary Notes 1 to 8, further comprising

a display control means configured to display information on the plural second candidates on a display device.

[Supplementary Note 10]

The information processing device according to Supplementary Note 9,

wherein the display control means is configured to display, on the display device, information on one or more common combinations of the sellers and the buyers among the plural second candidates.

[Supplementary Note 11]

The information processing device according to Supplementary Note 9 or 10,

wherein the display control unit is configured,
in a case where one of the plural second candidates is selected from the plural second candidates,
to display detailed information on the selected second candidate on the display device.

[Supplementary Note 12]

A control method executed by a computer, the control method comprising:

determining,
based on seller information indicating a sale condition of a transaction target presented by each of sellers and buyer information indicating a buy condition of the transaction target presented by each of buyers,
first candidates to be plural candidates for combinations of the sellers and the buyers establishing valid transactions of the transaction target; and

selecting plural second candidates to be displayed from the first candidates based on similarity among the first candidates.

[Supplementary Note 13]

A storage medium storing a program executed by a computer, the program causing the computer to function as:

a first candidate determination means configured to determine,
based on seller information indicating a sale condition of a transaction target presented by each of sellers and buyer information indicating a buy condition of the transaction target presented by each of buyers,
first candidates to be plural candidates for combinations of the sellers and the buyers establishing valid transactions of the transaction target; and

a second candidate selection means configured to select plural second candidates to be displayed from the first candidates based on similarity among the first candidates.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A, 1B Information processing device
2 Input device
3 Display device
4 Storage device
5 Terminal device
100, 100A Optimization system

What is claimed is:

1. An information processing device comprising:
at least one memory configured to store instructions; and
at least one processor configured to execute the instructions:
to obtain seller information indicating a sale condition of a transaction target presented by each of sellers and buyer information indicating a buy condition of the transaction target presented by each of buyers;
to determine first candidates to be plural candidates for combinations of the sellers and the buyers establishing valid transactions of the transaction target based on the seller information and the buyer information; and
to select plural second candidates to be displayed from the first candidates based on similarity among the first candidates.

2. The information processing device according to claim 1,
wherein the at least one processor is configured to execute the instructions to select the plural second candidates such that the lower the similarity among a set of first candidates is, the higher a possibility of selecting the set of the first candidates as the plural second candidates becomes.

3. The information processing device according to claim 1,
wherein the at least one processor is configured to execute the instructions to select the plural second candidates such that a possibility of selecting a first candidate as a second candidate increases with an increase in a profit of a mediator mediating the transactions of the transaction target to be obtained in case of the first candidate.

4. The information processing device according to claim 1,
wherein the at least one processor is configured to execute the instructions to select the plural second candidates through a sampling using determinantal point processes in which probability distributions based on the similarity are represented by a matrix.

5. The information processing device according to claim 1,
wherein the at least one processor is configured to execute the instructions to selects a number of the second candidates from the first candidates,
the number being specified by a user input.

6. The information processing device according to claim 1,
wherein the at least one processor is configured to execute the instructions to determine a predetermined number of the first candidates by executing plural number of combinatorial optimizations while changing conditions on each of the combinatorial optimizations,
each of the combinatorial optimizations determining the combinations of the sellers and the buyers to maximize a profit of a mediator mediating the transactions of the transaction target.

7. The information processing device according to claim 1,
wherein the at least one processor is configured to execute the instructions to determine,
based on the seller information, the buyer information, a profit of a mediator mediating the transactions of the transaction target, and transport information relating to transport of the transaction target from the sellers to the buyers,
a schedule of the transport for each of the first candidates.

8. The information processing device according to claim 7,
wherein the at least one processor is configured to execute the instructions to selects the plural second candidates based on the similarity among the first candidates that are candidates for combinations of the sellers, the buyers, and means of the transport.

9. The information processing device according to claim 1,
wherein the at least one processor is configured to further execute the instructions to display information on the plural second candidates on a display device.

10. The information processing device according to claim 9,
wherein the at least one processor is configured to execute the instructions to display, on the display device, information on one or more common combinations of the sellers and the buyers among the plural second candidates.

11. The information processing device according to claim 9,
wherein the at least one processor is configured to execute the instructions,
in a case where one of the plural second candidates is selected from the plural second candidates,
to display detailed information on the selected second candidate on the display device.

12. A control method executed by a computer, the control method comprising:
obtaining seller information indicating a sale condition of a transaction target presented by each of sellers and buyer information indicating a buy condition of the transaction target presented by each of buyers;
determining first candidates to be plural candidates for combinations of the sellers and the buyers establishing valid transactions of the transaction target based on the seller information and the buyer information; and
selecting plural second candidates to be displayed from the first candidates based on similarity among the first candidates.

13. A non-transitory computer readable storage medium storing a program executed by a computer, the program causing the computer to:
obtain seller information indicating a sale condition of a transaction target presented by each of sellers and buyer information indicating a buy condition of the transaction target presented by each of buyers;
determine first candidates to be plural candidates for combinations of the sellers and the buyers establishing valid transactions of the transaction target based on the seller information and the buyer information; and
select plural second candidates to be displayed from the first candidates based on similarity among the first candidates.
